(19) United States
(12) Patent Application Publication
(10) Pub. No.: US 2025/0235371 A1
(43) Pub. Date: Jul. 24, 2025

(54) MASSAGE MACHINE

(71) Applicant: DAITO ELECTRIC MACHINE INDUSTRY COMPANY LIMITED, Higashi-Osaka-shi, Osaka (JP)

(72) Inventors: Ken TAMAKI, Higashi-Osaka-shi (JP); XiongXiang ZHAO, Higashi-Osaka-shi (JP); Shinsaku SHIMIZU, Higashi-Osaka-shi (JP)

(73) Assignee: DAITO ELECTRIC MACHINE INDUSTRY COMPANY LIMITED, Higashi-Osaka-shi, Osaka (JP)

(21) Appl. No.: 18/855,523

(22) PCT Filed: Apr. 6, 2023
(86) PCT No.: PCT/JP2023/014231

§ 371 Date: Oct. 9, 2024

(30) Foreign Application Priority Data
Jun. 10, 2022 (JP) 2022-094596

(51) Int. Cl. A61H 7/00

(52) U.S. Cl. CPC A61H 7/007; A61H 2201/1215; A61H 2201/123; A61H 2201/164; A61H 2205/106

(57) ABSTRACT

A massage machine gives comfortable and effective massage to user's treatment areas of different widths and sizes (e.g., feet, or legs of different sizes, and calves of different thickness) using mechanism to adjust, in accordance with width or size of treatment area of a person using the machine, a spacing between massage members to sandwich the treatment area from both sides in lateral direction.

The massage machine (1) includes a pair of right and left massage members (6) that hold treatment area therebetween, and a width adjustment mechanism (12) to adjust a spacing between the massage members (6) in lateral direction. The width adjustment mechanism (12) includes a width adjuster (13) mounted to at least one of the massage members (6), for moving it in lateral direction, and guide shaft (14), mounted with its axis directed in width direction, for guiding the massage member (6) in lateral direction via the width adjuster (13).

### TECHNICAL FIELD

The present invention relates to a massage machine capable of adjusting, in accordance with the width or size of a treatment area of a user, the spacing between massage members that sandwich and hold the treatment area from both sides in a lateral direction.

### BACKGROUND ART

Massage machines currently on the market include one comprising a pair of right and left massage members arranged to sandwich an area to be treated (treatment area, e.g., a lower leg such as a foot or calf, or an arm) between them. The massage members perform massage operation, or specifically kneading or pressing massage, on the treatment area. For example, Patent Literature 1 discloses a massage machine configured to effect massage action on a lower leg, including a foot and a calf, by moving paired right and left massage members toward and away from each other to press or knead the lower leg.

### PRIOR ART REFERENCE

### Citation List

Patent Literature 1: Japanese Examined Patent Publication JP-B2 5912548

### SUMMARY OF INVENTION

### Technical Problem

The massage machine disclosed in Patent Literature 1 is of use to give a highly effective massage treatment to a treatment area.

As a known fact, individual massage machine users have different foot (lower leg) sizes, different calf thickness, and different arm thickness, that is; the treatment areas of users vary in width and size. Unfortunately, traditional massage machines often include paired right and left massage members arranged at a fixed spacing.

For example, a user having a relatively thick calf may feel that the fixed space between the massage members is tight. The massage members, if receiving the relatively thick calf in the space between them, can be forcibly caused to warp outward to widen the space. The warpage puts an unintended load on the massage members, a drive shaft for kneading massage, etc. This can result in failure of the massage machine to perform massage operation smoothly.

On the other hand, a user having a relatively thin calf may feel that the fixed space between the massage members is larger than it needs to be. The massage members, if receiving the relatively thin calf in the larger-than-necessary space between them, cannot make close contact with the calf. In this case, the degree of pressing force applied to the calf by the massage members is so low that the calf cannot be kneaded with adequate strength. This can result in failure of the massage machine to provide sufficiently high massage effect.

There has thus been awaited a massage machine including a mechanism capable of adjusting, in accordance with the width or size of a treatment area of a user, the spacing between massage members that sandwich and hold the treatment area from both sides in a lateral direction.

In response to the above issue, it is an object of the present invention to provide a massage machine which is capable of giving comfortable and effective massage to treatment areas of different widths and sizes (e.g., feet, or lower legs of different sizes, and calves of different thickness) of users by using a mechanism that adjusts, in accordance with the width or size of a treatment area of a person using the massage machine, the spacing between massage members that sandwich and hold the treatment area from both sides in a lateral direction.

### Solution to Problem

To achieve the above object, example embodiments of the present invention have the following technical features.

A massage machine according to an example embodiment of the present invention includes a pair of right and left massage members to hold a treatment area therebetween, and a width adjustment mechanism to adjust a spacing in a lateral direction between the massage members. The width adjustment mechanism includes a width adjuster mounted to at least one of the massage members to enable the at least one massage member to move in the lateral direction, and a guide shaft having an axis directed in the lateral direction to guide the at least one massage member in the lateral direction via the width adjuster.

In the example embodiment, the width adjuster may sandwich the at least one massage member from both sides in the lateral direction, the guide shaft may be passed through the width adjuster in the lateral direction, and the width adjuster may be configured to adjust the spacing in the lateral direction between the massage members by moving on the guide shaft in the lateral direction.

In the example embodiment, the width adjuster may include a pair of plates to sandwich the at least one massage member therebetween on both sides in the lateral direction, the plates each including an opening to keep clear of a kneading drive shaft which is passed through a base end of the at least one massage member, and a coupler to connect the pair of plates to each other, the coupler including a horizontal hole extending in the lateral direction, the guide shaft may be passed through the horizontal hole, and the width adjuster may be configured to adjust the spacing in the lateral direction between the pair of right and left massage members in such a manner that the width adjuster is guided on the guide shaft to move the at least one massage member fitted with the width adjuster in the lateral direction.

In the example embodiment, the guide shaft may include an outer periphery formed with an external thread in helical form, the horizontal hole may include an inner periphery formed with an internal thread with which the external thread of the guide shaft threadedly engages, and the width adjuster may be configured to adjust the spacing in the lateral direction between the pair of right and left massage members in such a manner that, upon a rotation of the guide shaft, the width adjuster is guided with the internal thread engaging the external thread on the guide shaft to move the at least one massage member fitted with the width adjuster in the lateral direction.

In the example embodiment, a left-leg massager and a right-leg massager may be juxtaposed in the lateral direction, the left-leg massager and the right-leg massager may each include the pair of right and left massage members, the guide shaft may be extended in the lateral direction to pass through the horizontal hole of the width adjuster included in the left-leg massager and the horizontal hole of the width adjuster included in the right-leg massager, and the external threads and the internal threads engaging each other may be configured to adjust the spacings in the lateral direction each of which is between the corresponding pair of massage members in such a manner that, upon a rotation of the guide shaft in one direction, engagement of the external threads and the internal threads causes the at least one massage member of the left-leg massager and the at least one massage member of the right-leg massager to move away from each other, and, upon a rotation of the guide shaft in a reverse direction, engagement of the external threads and the internal threads causes the at least one massage member of the left-leg massager and the at least one massage member of the right-leg massager to move close to each other.

In the example embodiment, the guide shaft may be provided with the external threads, including a right-leg massager-side external thread formed on a portion thereof toward the left-leg massager, and a left-leg massager-side external thread formed on another portion thereof toward the right-leg massager, the right-leg massager-side external thread may be a screw whose threading direction is opposite to that of the left-leg massager-side external thread, and the width adjuster of the left-leg massager and the width adjuster of the right-leg massager may be configured to adjust the spacings in the lateral direction each of which is between the corresponding pair of massage members in such a manner that, upon a rotation of the guide shaft, the width adjuster of the left-leg massager and the width adjuster of the right-leg massager move close to and away from each other with the respective internal threads engaging the respective external threads.

In the example embodiment, the base end of the at least one massage member may be provided with a converter to convert a rotational driving force into rocking motion, and the converter may be slidable in the lateral direction relative to the kneading drive shaft that is passed through the converter.

In the example embodiment, the converter may include a rotary boss mounted to the kneading drive shaft to be rotatable together with the kneading drive shaft, and an annular fitter on the base end of the at least one massage member and fitted externally to the rotary boss, and the rotary boss may be slidable in the lateral direction relative to the kneading drive shaft.

In the example embodiment, the kneading drive shaft may include a through hole formed therethrough and extending orthogonally to an axis of the kneading drive shaft, a slide pin may be fitted in the through hole, the slide pin may be of such a length as to extend radially of the kneading drive shaft and protrude outward from the kneading drive shaft, the rotary boss may include a hole through which the kneading drive shaft is passed, the hole may be formed with a guide slot shaped as a long groove extending axially of the kneading drive shaft, the guide slot may receive the slide pin slidably fitted thereinto, and the guide slot and the slide pin that are guidable in the lateral direction may be configured to adjust the spacing in the lateral direction between the massage members by guiding the rotary boss in rectilinear sliding movement on the kneading drive shaft in the lateral direction.

### Advantageous Effects of Invention

According to one aspect of the present invention, the massage machine is capable of giving comfortable and effective massage to treatment areas of different widths and sizes (e.g., feet, or lower legs of different sizes, and calves of different thickness) of users by using the mechanism that adjusts, in accordance with the width or size of a treatment area of a person using the massage machine, the spacing between the massage members that sandwich and hold the treatment area from both sides in a lateral direction.

### BRIEF DESCRIPTION OF THE DRAWINGS

FIG. 1 is a view schematically showing the general configuration of a massage machine according to one or more example embodiments of the present invention.

FIG. 2 is a front perspective view showing the internal structure of the massage machine according to one or more example embodiments of the present invention.

FIG. 3 is a rear perspective view showing the internal structure of the massage machine according to one or more example embodiments of the present invention.

FIG. 4 is a back view showing the internal structure of the massage machine according to one or more example embodiments of the present invention.

FIG. 5 is an enlarged view showing the structure of a right width adjustment mechanism of the massage machine.

FIG. 6 is an enlarged view showing the structure of a left width adjustment mechanism of the massage machine.

FIG. 7 is a sectional view showing the structure of the right width adjustment mechanism.

### DESCRIPTION OF EMBODIMENTS

A massage machine 1 according an embodiment of the present invention will now be described with reference to the drawings.

The following embodiment is given by way of example of carrying the present invention into practice, and hence is not intended to be limiting of the structural features of the present invention. In the drawings, some constituent components are not shown or are indicated by imaginary lines or similar representation for clarity of illustration.

As exemplary of the massage machine 1 according to an example embodiment of the present invention, a massage machine for lower leg 1, being called a lower leg massager 1, will now be described.

The directions with respect to the lower leg massager 1, including a front-rear direction, and a right-left direction, or lateral direction, are as shown in the drawings. These directions coincide with those as viewed from a user sitting in a chair or similar furniture with a lower leg L of the user received in the lower leg massager 1. The directions indicated in the drawings are used as the reference to describe the lower leg massager 1.

In this description, an area of human lower leg L from a below-knee part to a malleolus K (i.e., ankle K) is referred to as “calf C”. Moreover, an area of the lower leg L from the ankle K to a toe S is referred to as “foot F”. Other areas of the lower leg L will be described on an as-needed basis.

The massage machine 1 according to the example embodiment of the present invention is characterized in that it includes a width adjustment mechanism 12 to permit width adjustment for a pair of massage members 6a and 6b. The present example embodiment exemplifies an arrangement in which the massage member 6a placed toward the outer side of the lower leg L, being called the outer massage member 6a, is movable via the width adjustment mechanism 12. The massage member 6b placed toward the inner side of the lower leg L, being called the inner massage member 6b, may be movable instead. In another alternative, both the outer massage member 6a and the inner massage member 6b may be movable.

The lower leg massager 1 according to the present example embodiment is configured to massage, as massage target areas (treatment areas), the right and left lower legs L (i.e., the right and left belowknee-to-toe areas) of the user. The lower leg massager 1 applies holding-kneading massage to the calf C and the foot F forming each of the right and left lower legs L. The lower leg massager 1 is also capable of applying pressing massage to the back side of the calf C and a sole U.

Moreover, the lower leg massager 1 according to the present example embodiment is configured to adjust the spacing (width) between the pair of right and left massage members 6.

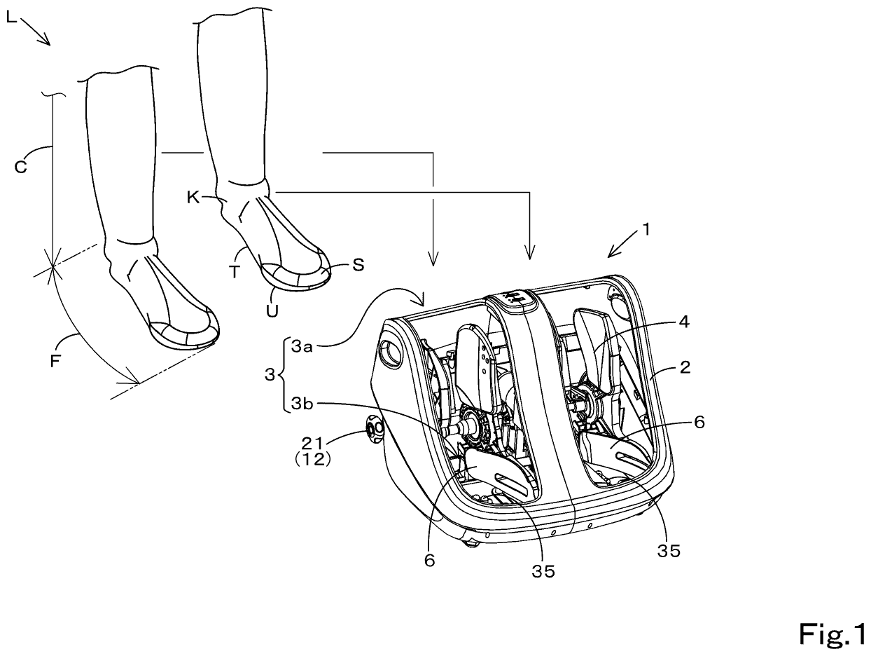

As shown in FIG. 1, the lower leg massager 1 according to the present example embodiment includes a case body 2 which is substantially square-shaped when viewed from the front, and is boot-shaped when viewed from the side. The case body 2 is provided at each of the right and left side walls with a handgrip for easy carrying of the lower leg massager 1. The direction from the right to the left of the case body 2, or equivalently the lateral direction of the case body 2, corresponds to a width direction.

The case body 2 includes a front face formed with a pair of left and right recesses for massage treatment 3, being called treatment recesses 3, for receiving the lower legs L. In other words, the treatment recesses 3 are spaced apart in the lateral direction. The left treatment recess 3 receives the left lower leg L, and the right treatment recess 3 receives the right lower leg L.

The treatment recesses 3 each include an upper treatment recess 3a and a lower treatment recess 3b. The upper treatment recess 3a, defining substantially an upper half portion of the treatment recess 3, is open at the front and at the top. The lower treatment recess 3b, defining substantially a lower half portion of the treatment recess 3, is open at the top and at the front. The upper treatment recess 3a and the lower treatment recess 3b communicate with each other in a top-bottom direction, or vertical direction. While the calf C fits in the upper treatment recess 3a, the foot F fits in the lower treatment recess 3b concurrently.

A cushion member made of a sponge or urethane body, or a similar material (not shown) is provided in the inside of the upper treatment recess 3a and the lower treatment recess 3b. In addition, a lining made of a stretchable material having adequate air permeability, such as a cloth or leather material (not shown), is provided at the opening (surface) of the upper treatment recess 3a and the lower treatment recess 3b.

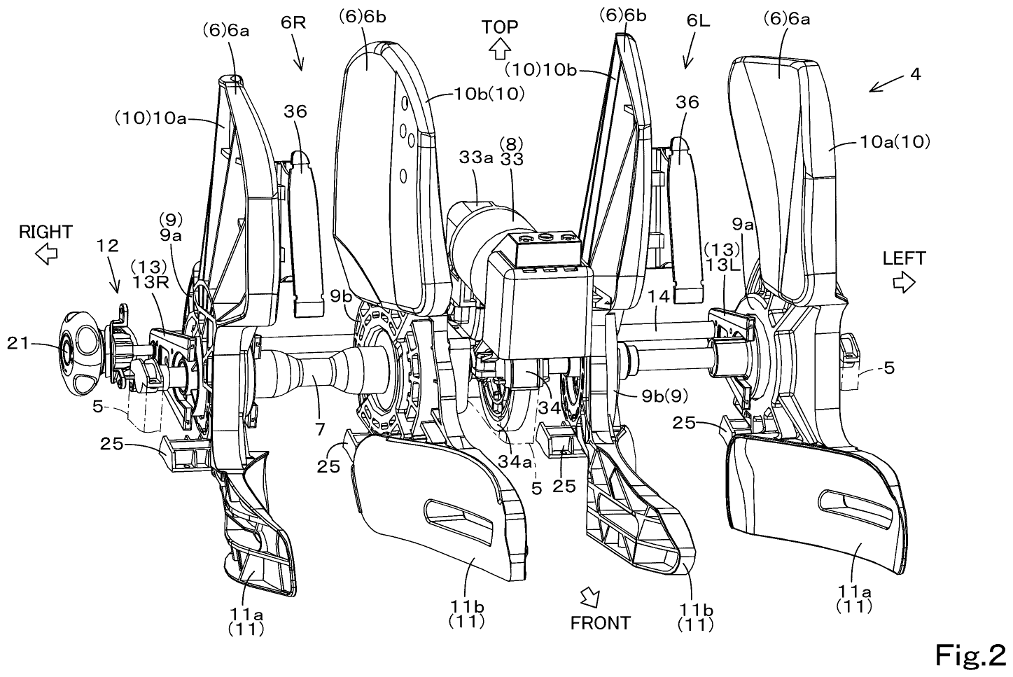

As shown in FIG. 2, the case body 2 has an interior for accommodating a massage mechanism 4. In the interior of the case body 2, a plurality of supports 5 are mounted to support the massage mechanism 4 from below. In the present example embodiment, three supports 5, namely two supports 5 located one at each side of the interior of the case body 2 in the lateral direction and one middle support 5, are arranged equidistantly. The two supports 5 on both sides support the right and left ends, respectively, of a drive shaft for kneading massage 8, being called kneading drive shaft 8, which constitutes the massage mechanism 4, in a manner such that the kneading drive shaft is supported for free rotation via a bearing. The middle support 5 supports a gear case 34 of a driver for kneading massage 8, being called kneading driver 8, with the kneading drive shaft 8 passing through the gear case 34. That is, the supports 5 provide three-point support for the massage mechanism 4. This enables the massage mechanism 4 to be held in a position elevated above the bottom of the interior of the case body 2.

As shown in the drawings such as FIGS. 2 to 4, the massage mechanism 4 includes the paired right and left massage members 6 spaced apart in the lateral direction, the kneading drive shaft 7, the kneading driver 8, and a converter 9. The massage members 6 effect kneading massage action on the calf C and the foot F of the lower leg L. The kneading drive shaft 7 having an axis directed in the lateral direction (width direction) extends across the right and left ends of the interior of the case body 2. The kneading driver 8 rotatably drives the kneading drive shaft 7. The converter 9 converts a rotational driving force exerted by the kneading drive shaft 7 into rocking motion of the massage members 6.

The massage members 6 are mounted as a pair of right and left massage members to hold the treatment area (lower leg L) between them. More specifically, the massage members 6 are spaced apart in the lateral direction (width direction) to hold the calf C and the foot F between them. This arrangement allows kneading massage to be performed on the calf C and the foot F of the lower leg L.

Each of the massage members 6 is a plate having an undulating contact surface conforming to the shape of the calf C-to-foot F area. The massage members 6 include the outer massage member 6a and the inner massage member 6b. The outer massage member 6a is located to face the outer side of the lower leg L, and the inner massage member 6b is located to face the inner side of the lower leg L.

The spacing between the outer massage member 6a and the inner massage member 6b is defined as a width between the paired right and left massage members 6. The width, or specifically the dimension of the space for receiving the lower leg L in the lateral direction, is adjustable in a stepless manner by imparting horizontal movement to the corresponding massage member 6 via a width adjustment mechanism 12 (as will hereinafter be described).

The massage members 6a and 6b, paired in the lateral direction, each include a vertical massager 10 and a horizontal massager 11. The vertical massager 10 effects kneading massage action on the calf C. The horizontal massager 11 effects kneading massage action on the foot F.

The vertical massager 10 protrudes substantially vertically upwards from a location toward the bottom of the interior of the case body 2. The vertical massager 10 is shaped so as to cover the calf C laterally, and has an upper end (front end) portion that covers the upper side of the calf C, and a rear end (base end) portion that covers the lower side of the calf C.

The outer massage member 6a (which faces the outer side of the lower leg) includes a vertical massager 10a shaped so as to cover the lateral (outer) side of the calf C. The inner massage member 6b (which faces the inner side of the lower leg) includes a vertical massager 10b shaped so as to cover the medial (inner) side of the calf C.

The paired right and left vertical massagers 10 are arranged so as hold the calf C between them within the upper treatment recess 3a. The paired vertical massagers 10 effect kneading massage action on the calf C received in the upper treatment recess 3a by sandwiching and pressing the calf C from the inner and outer sides in the lateral direction. Each vertical massager 10 is provided at the base end (lower end) with the converter 9 that converts the rotational driving force exerted by the kneading drive shaft 7 into rocking motion.

The horizontal massager 11 protrudes substantially horizontally forwards from a location toward the rear of the interior of the case body 2. The horizontal massager 11 is shaped so as to cover the foot F laterally, and has a forward end (front end) portion that covers the toe S, and a rear end (base end) portion that covers the heel K.

The outer massage member 6a (which faces the outer side of the lower leg) includes a horizontal massager 11a shaped so as to cover the lateral (outer) side of the foot F (toe S-to-heel K area). The inner massage member 6b (which faces the inner side of the lower leg) includes a horizontal massager 11b shaped so as to cover the medial (inner) side of the foot F (toe S-to-heel K area).

The paired right and left horizontal massagers 11 are arranged so as hold the foot F between them within the lower treatment recess 3b. The paired horizontal massagers 11 effect kneading massage action on the foot F received in the lower treatment recess 3b by sandwiching and pressing the foot F from the inner and outer sides in the lateral direction. Each horizontal massager 11 is provided at the base end (rear end) with the converter 9 that converts the rotational driving force exerted by the kneading drive shaft 7 into rocking motion. That is, the vertical massager 10 and the horizontal massager 11 are coupled to each other, with the converter 9 lying between them.

In the present example embodiment, the massage member 6 has a single-piece form of boot-like shape (substantially L shape), as viewed from the side, in conformance with the shape of the lower leg L, i.e., the area extending continuously from the calf C through the foot F. The converter 9 is situated at a bend in the substantially L-shaped massage member 6.

In other words, the massage member 6 includes the vertical massager 10 protruding substantially vertically upwards from the converter 9, and the horizontal massager 11 protruding substantially horizontally forwards from the converter 9. The converter 9 is located slightly closer to the rear of the massage machine than the base ends of the vertical and horizontal massagers 10 and 11. The mounting position of the converter 9 corresponds to the base end of the massage member 6 as a whole.

The massage machine 1 according to the present example embodiment includes a massager 6L for left leg, being called left-leg massager 6L, and a massager 6R for right leg, being called right-leg massager 6R. The left-leg massager 6L and the right-leg massager 6R are arranged in juxtaposition as a pair in the lateral direction. The left-leg massager 6L includes the massage members 6a and 6b for the left lower leg L, and the right-leg massager 6R includes the massage members 6a and 6b for the right lower leg L.

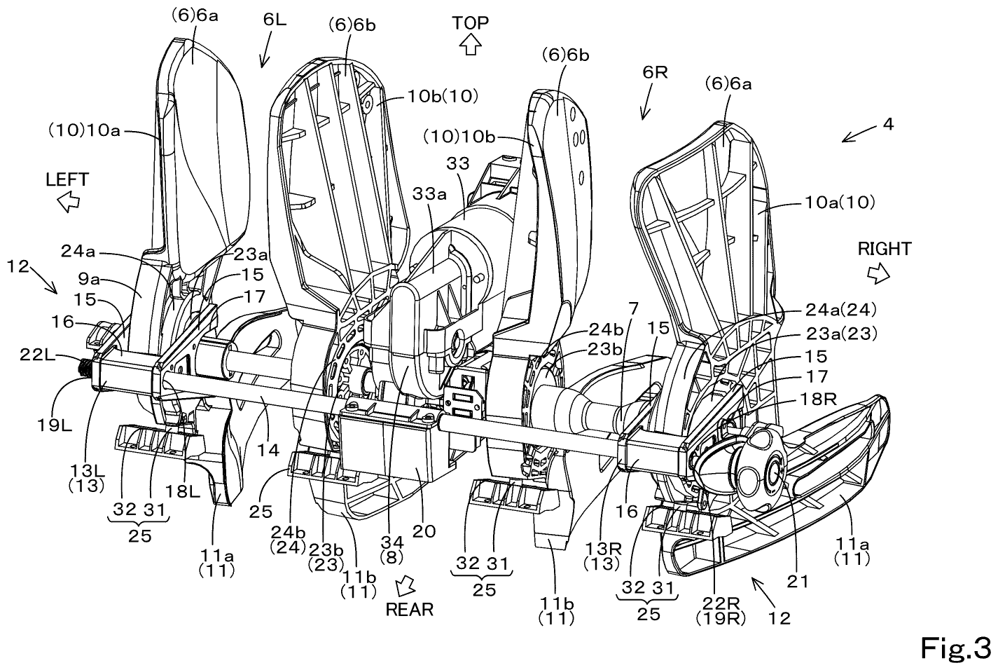

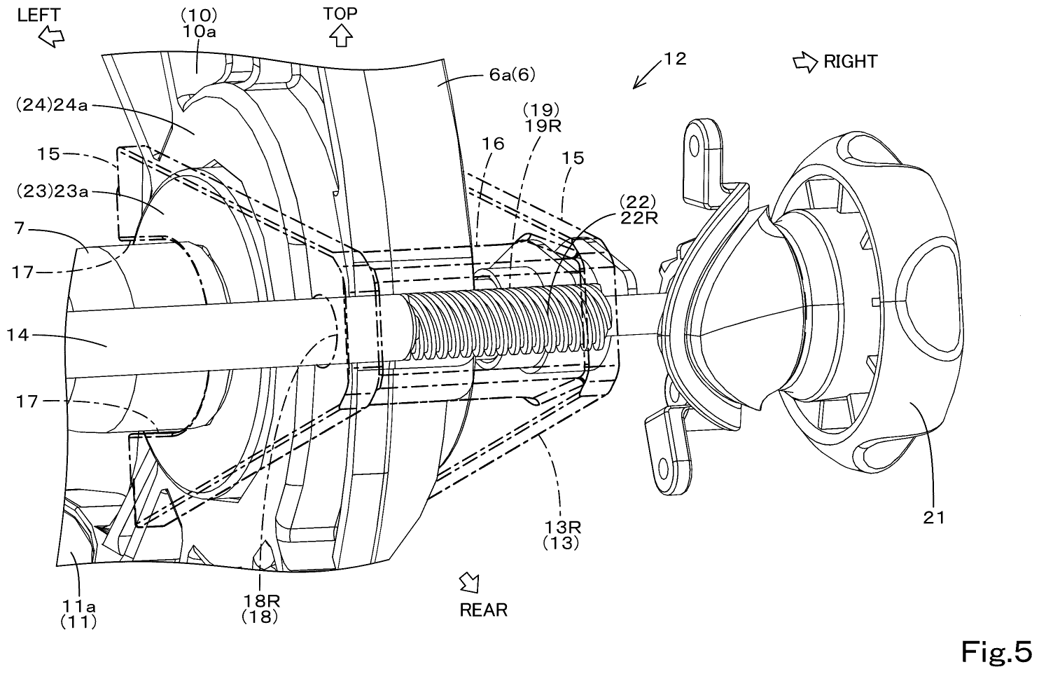

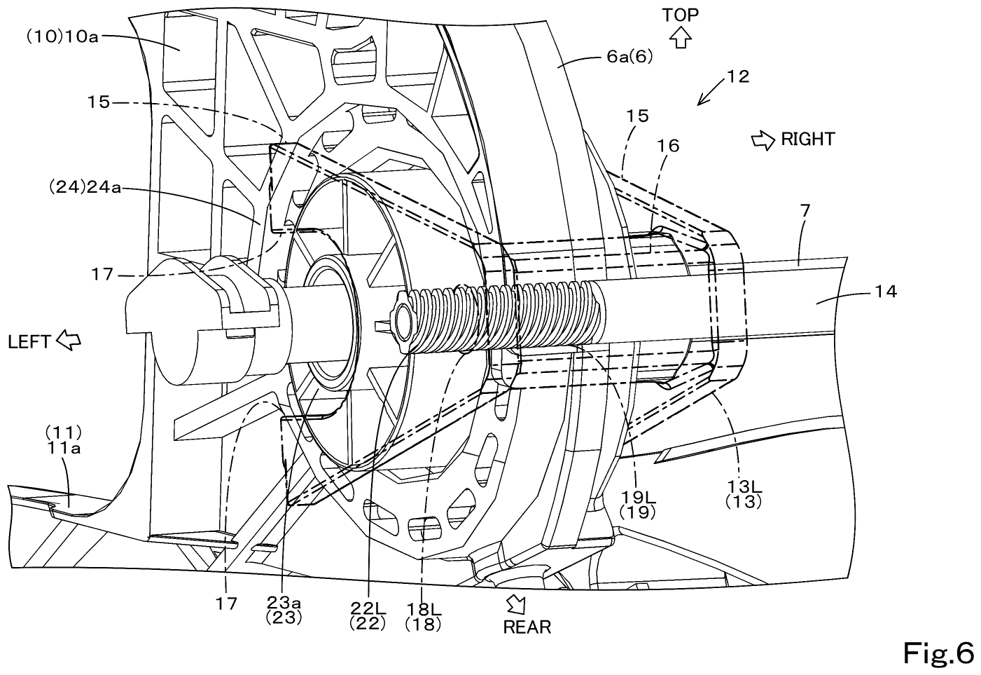

As shown in the drawings such as FIGS. 3 to 7, the massage member 6 is provided at the rear side with the width adjustment mechanism 12 to steplessly adjust the spacing between the paired massage members 6 in the lateral direction (width direction).

The general configuration of the width adjustment mechanism 12 will be described first.

The width adjustment mechanism 12 includes a width adjuster 13 and a guide shaft 14. The width adjuster 13 enables the massage member 6a to move horizontally. The guide shaft 14 guides the width adjuster 13 in horizontal movement.

The width adjuster 13 is formed with an internal thread 19, whereas the guide shaft 14 is formed with an external thread 22. The engagement of the external thread 22 with the internal thread 19 enables the width adjuster 13 to horizontally move on the guide shaft 14 in the lateral direction. In the present example embodiment, the guide shaft 14 for moving the width adjuster 13 in the lateral direction is provided independently of the kneading drive shaft 7.

The converter 9, which eccentrically rotates with respect to the kneading drive shaft 7, is located at the base end of the massage member 6a. The converter 9 is mounted for free movement relative to the kneading drive shaft 7 in the lateral direction. The converter 9 is held by the width adjuster 13 in sandwich style. This enables the width adjuster 13 to control the movement of the converter 9 in the lateral direction.

With the converter 9 mounted for movement relative to the kneading drive shaft 7, the massage member 6a is movable in the lateral direction. This permits width (spacing) adjustment for the paired massage members 6a and 6b.

The width adjustment mechanism 12 will now be described in further detail.

In the present example embodiment, the width adjustment mechanism 12 is located at the rear of each of the outer massage members 6a. The width adjustment mechanism 12 enables the outer massage member 6a to horizontally move in the width direction. That is, in the present example embodiment, the width adjustment mechanisms 12 allow concurrent horizontal movements of the outer massage member 6a of the left-leg massager 6L and the outer massage member 6a of the right-leg massager 6R in the width direction. This permits adjustment of both the width of space for the left lower leg L and the width of space for the right lower leg L.

The width adjustment mechanism 12 includes the width adjuster 13 mounted to at least one of the massage members 6, and the guide shaft 14 mounted with its axis directed in the width direction. The width adjuster 13 enables the at least one massage member 6 to move in the width direction. The guide shaft 14 guides the massage member 6 in widthwise movement via the width adjuster 13.

The width adjuster 13 sandwiches the massage member 6 from both sides in the lateral direction. In the present example embodiment, right and left width adjusters 13 are provided as a pair.

The left width adjuster 13L is mounted to the base end of the outer massage member 6a of the left-leg massager 6L. The right width adjuster 13R is mounted to the base end of the outer massage member 6a of the right-leg massager 6R.

Each of the width adjusters 13 has the form of an open-front U-shaped member, that is; each width adjuster 13 is open at the top, at the bottom, and at the front. The width adjuster 13 is attached to the massage member 6 from the rear of the base end of the massage member 6. The width adjuster 13 includes a pair of plates 15 and a coupler 16. The plates 15 hold the massage member 6 therebetween on both sides in the lateral direction. The coupler 16 connects the rear portions of the paired plates 15 together.

Each of the plates 15 is a trapezoidal member which has a predetermined plate thickness and increases its width gradually toward the front. That is, the plate 15 is longer at the front edge than at the rear edge in the top-bottom direction. The length of the front edge of the plate 15 is greater than the inside diameter of an annular fitter 24 of the converter 9. The length of the rear edge of the plate 15 is greater than the outside diameter of the guide shaft 14. In the present example embodiment, the length of the plate 15 in the front-rear direction corresponds to a distance from the forward end of the converter 9 of the massage member 6 to the position of the guide shaft 14 located toward the rear, as seen in side view.

The spacing between the paired right and left plates 15 (the interior clearance in the width adjuster 13) is substantially equal to the width of the converter 9 mounted to the massage member 6. That is, the width adjuster 13 is fitted externally to the converter 9.

The plate 15 is formed with a cut-out portion 17 to keep clear of the kneading drive shaft 7 passing through the base end of the massage member 6. The cut-out portion 17 is made as an opening extending from the front side of the plate 15 to a lengthwise intermediate point thereof. The opening width of the cut-out portion 17 in the top-bottom direction is large enough for the kneading drive shaft 7 to pass through the opening, and is greater than the outside diameter of a rotary boss 23 of the converter 9. That is, the plate 15 has an open-front U-shaped form, as seen in side view.

The coupler 16 is sandwiched between the rear portions of the paired right and left plates 15, That is, the widthwise length of the coupler 16 is substantially equal to the spacing between the paired right and left plates 15. Moreover, the vertical length of the coupler 16 is substantially equal to the length of the rear edge of the plate 15. The coupler 16, being formed integrally with the rear portions of the paired right and left plates 15, connects the paired right and left plates 15 together, thereby constituting the width adjuster 13.

In side view, the coupler 16 has a size greater than the outside diameter of the guide shaft 14. The coupler 16 is formed with a horizontal hole 18 having an axis directed in the width direction. The horizontal hole 18 is formed through the coupler 16, as well as through the rear portions of the paired right and left plates 15. The inside diameter of the horizontal hole 18 is substantially equal to the outside diameter of the guide shaft 14. That is, the guide shaft 14 is passed through the horizontal hole 18.

The horizontal hole 18 includes an inner periphery formed with the internal thread 19 in helical form with which the external thread 22 formed in the guide shaft 14 (as will hereinafter be described) threadedly engages.

In the present example embodiment, a left horizontal hole 18L is formed with an internal thread 19L with which an external thread 221 of the guide shaft 14 (as will hereinafter be described) threadedly engages. Moreover, a right horizontal hole 18R is formed with an internal thread 19R with which an external thread 22R of the guide shaft 14 (as will hereinafter be described) threadedly engages. The internal thread 19L and the internal thread 19R are screws whose threading directions are opposite to each other (as will hereinafter be detailed).

The guide shaft 14 is an elongated shaft body mounted with its axis directed horizontally in the lateral direction (width direction). The guide shaft 14 is mounted so as to extend from the left end of the interior of the case body 2 to the right end thereof. The guide shaft 14 is supported by a support 20 situated rearward of the kneading driver 8 (located centrally of the rear portion of the interior of the case body 2). In the present example embodiment, the guide shaft 14 is situated rearward of the kneading drive shaft 7, and also situated rearward of the base end of the massage member 6.

Moreover, in the present example embodiment, the guide shaft 14 is provided at the right end with an adjustment grip 21. The user is able to make both width adjustment for the left-leg massager 6L and width adjustment for the right-leg massager 6R by holding and turning the adjustment grip 21 with the hand.

The guide shaft 14 is mounted so as to pass through the width adjuster 13 in the width direction. In the present example embodiment, the guide shaft 14 is passed through the horizontal hole 18L of the width adjuster 13L provided in the left-leg massager 61 (the outer massage member 6a for the left lower leg L), and also passed through the horizontal hole 18R of the width adjuster 13R provided in the right-leg massager 6R (the outer massage member 6a for the right lower leg L).

The guide shaft 14 includes an outer periphery formed with the external thread 22 in helical form. In the present example embodiment, the left-end portion of the guide shaft 14 is formed with the helical external thread 22L. The external thread 22L threadedly engages the internal thread 19L of the left width adjuster 13L. In addition, the right-end portion of the guide shaft 14 is formed with the helical external thread 22R. The external thread 22R threadedly engages the internal thread 19R of the right width adjuster 13R.

In the guide shaft 14, the external thread 22R located toward the right-leg massager 6R is a screw whose threading direction is opposite to that of the external thread 22L located toward the left-leg massager 6L (formed at the left-end portion of the guide shaft 14). Correspondingly, the internal thread 19R and the internal thread 19L are screws whose threading directions are opposite to each other.

The reason for using the external thread 22L and the external thread 22R formed as screws whose threading directions are opposite to each other is to produce the approach-separation movement of the outer massage member 6a for the left lower leg L and the approach-separation movement of the outer massage member 6a for the right lower leg L at the same time simply by rotating the guide shaft 14. This operation allows easy width adjustment for the massage members 6.

For example, upon a turn of the adjustment grip 21 in one direction, the guide shaft 14 is rotated in the one direction, causing the external thread 22 and the internal thread 19 to engage each other. The engagement allows the width adjuster 13 to be guided in movement on the guide shaft 14 in the width direction (lateral direction), and thus, while the left width adjuster 13L moves outward to the left, the right width adjuster 13R moves outward to the right concurrently. This enables the outer massage member 6a of the left-leg massager 6L and the outer massage member 6a of the right-leg massager 6R to horizontally move away from each other.

On the other hand, upon a turn of the adjustment grip 21 in a reverse direction, the guide shaft 14 is rotated in the reverse direction, causing the external thread 22 and the internal thread 19 to engage each other. The engagement allows the width adjuster 13 to be guided in movement on the guide shaft 14 in the width direction (lateral direction), and thus, while the left width adjuster 13L moves inward to the right, the right width adjuster 13R moves inward to the left concurrently. This enables the outer massage member 6a of the left-leg massager 6L and the outer massage member 6a of the right-leg massager 6R to horizontally move close to each other.

This process of operation enables the width adjusters 13L and 13R to move in the width direction, and thereby permits stepless widthwise-spacing adjustment for the paired right and left outer massage members 6a.

At the base end of the massage member 6, the kneading drive shaft 7 is located so as to pass through the base end. The kneading drive shaft 7 is an elongated shaft body which is mounted with its axis directed in the width direction, and situated forward of the guide shaft 14. Like the guide shaft 14, the kneading drive shaft 7 extends from the left end of the interior of the case body 2 to the right end thereof. The kneading drive shaft 7 is supported, via bearings, by three supports 5, of which two are located toward the left end and the right end, respectively, of the interior of the case body 2, and one is located centrally of the interior. The kneading drive shaft 7 is mounted so as to pass through the base end of the left-leg massager 6L and the base end of the right-leg massager 6R in the lateral direction. The kneading drive shaft 7 rotates under the rotational driving force outputted from the kneading driver 8.

The massage member 6 is provided at the base end with the converter 9 that converts a rotational driving force into rocking motion. The converter 9, through which the kneading drive shaft 7 passes, is mounted for free sliding motion relative to the kneading drive shaft 7 in the width direction. That is, the width adjustment mechanism 12 includes an arrangement to allow free widthwise sliding motion of the converter 9.

The converter 9 includes the rotary boss 23, the annular fitter 24, and a restrainer 25. The rotary boss 23 is rotatably mounted to the kneading drive shaft 7, and rotates in unitary relation with the kneading drive shaft 7. The annular fitter 24 is mounted to the base end of the massage member 6, and fitted externally to the rotary boss 23. The restrainer 25 restrains the massage member 6 from rotating together with the kneading drive shaft 7. The rotary boss 23 is formed with a hole 26 for receiving the kneading drive shaft 7 therethrough.

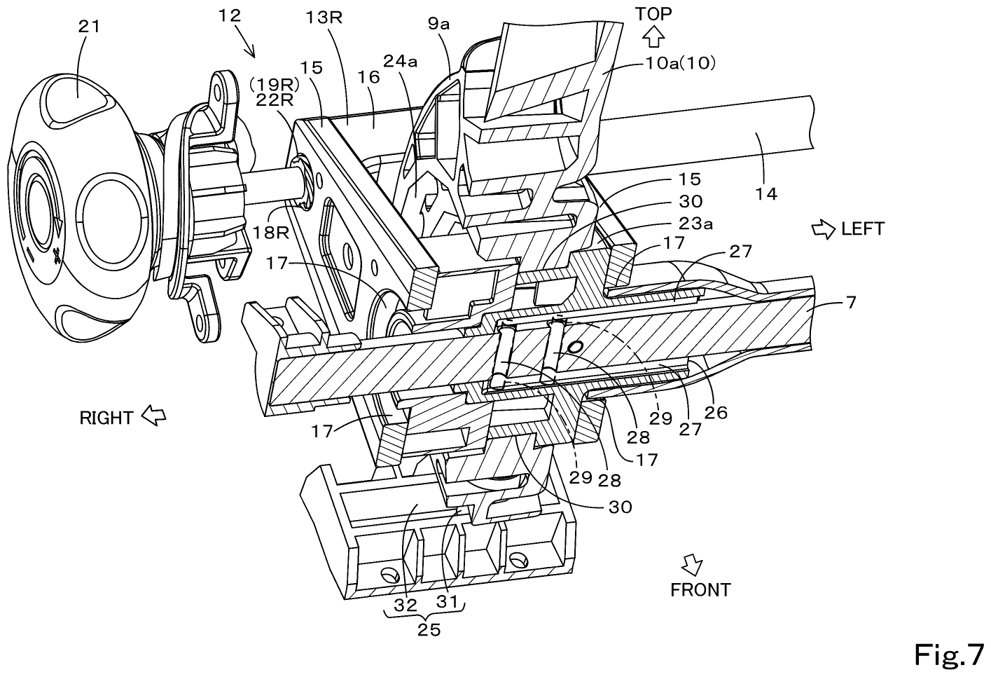

As shown in FIG. 7, in the present example embodiment, an outer rotary boss 23a includes a hole 26a formed with a guide slot 27 constituting the width adjustment mechanism 12. The guide slot 27, located at the outer periphery of the hole 26, is shaped as a long groove elongated in the direction of the axis of the kneading drive shaft 7.

The guide slot 27 has an opening in the inner wall surface of the outer rotary boss 23a, and is formed so as to extend outward from the opening (deep inside) as a rectangular groove. Two guide slots 27 are arranged in opposed positions as a pair, with the hole 25 lying between them. The guide slots 27 each communicate with the hole 26. In other words, the guide slot 27 is formed as a tubular groove having a closed bottom located outward in the width direction, like a key groove having a rectangular sectional configuration as seen in a direction intersecting the groove axis. The guide slot 27 receives a slide pin 29 for free sliding motion. The slide pin 29 is mounted to the kneading drive shaft 7.

Meanwhile, the kneading drive shaft 7 has a through hole 28 formed therethrough in a direction orthogonal to its axis. The through hole 28 is located inwardly of each end of the kneading drive shaft 7. In the present example embodiment, two through holes 28 are arranged side-by-side in the axial direction of the kneading drive shaft 7. In the present example embodiment, the positions of the through holes 28 correspond to the position of the outer massage member 6a.

The slide pin 29 is fitted in each through hole 28. The slide pin 29 is of such length as to extend outward in a direction radially of the kneading drive shaft 7. The length of the slide pin 29 is substantially equal to the distance (length) between the outer edges of, respectively, the paired guide slots 27 opposed to each other. When fitting in the through hole 28, the slide pin 29 mounted to the kneading drive shaft 7 can be slidably inserted in the guide slot 27.

The range of sliding movement of the outer rotary boss 23a is limited to between the opening of the guide slot 27 and the inner wall surface thereof located outward in the width direction. While the slide pin 29 is stationary, the guide slot 27 is movable, and the guide slot 27 moves on the kneading drive shaft 7 along the guide pin 29 accordingly.

The guide slot 27 of the outer rotary boss 23a and the slide pin 29 of the kneading drive shaft 7 guide the outer rotary boss 23a in rectilinear sliding movement on the kneading drive shaft 7 in the width direction. This permits stepless adjustment of the widthwise spacing between the massage members 6a and 6b paired in the lateral direction.

That is, the width adjustment mechanism 12 includes an arrangement that allows widthwise movement of the massage member 6a. In this arrangement, to impart widthwise sliding motion to the converter 9, the guide slot 27 is provided in the hole 26 of the rotary boss 23, and the slide pin 29 is mounted in the through hole 28 of the kneading drive shaft 7. With the slide pin 29 slidably fitted in the guide slot 27, the massage member 6a is movable in the width direction.

While the width adjustment mechanism 12 is manually operated in the present example embodiment, it may alternatively be designed so that the guide shaft 14 is automatically rotated via a motor. For automatic operation of the width adjustment mechanism 12, a sensor or limit switch is provided to detect the position of the width adjuster 13.

The converter 9 is located on the base-end side of the massage member 6. In the present example embodiment, the converter 9 is situated at the bend in the boot-shaped (substantially L-shaped) massage member 6, expressed differently, the converter 9 lies between the horizontal massager 11 and the vertical massager 10.

For example, an outer converter 9a is located between the horizontal massager 11a and the vertical massager 10a. In addition, an inner converter 9b is located between the horizontal massager 11b and the vertical massager 10b.

The converter 9 converts the rotational driving force exerted by the kneading drive shaft 7 into approach and separation movements (rocking motion) of the horizontal massagers 11 and the vertical massagers 10, thereby allowing kneading massage action to be transmitted to the massage members 6.

The rotary boss 23 rotates in unitary relation with the kneading drive shaft 7. The rotary boss 23 is provided at the outer periphery with a cam surface 30 inclined with respect to the kneading drive shaft 7. The cam surface 30 causes the rotary boss 23 to rotate with inclination relative to the axis of the kneading drive shaft 7.

Moreover, the hole 26 of the rotary boss 23 has an axis eccentric with respect to the axis of rotation of the cam surface 30. The hole 26 receives the kneading drive shaft 7 therethrough. The rotary boss 23 rotates eccentrically with respect to the axis of the kneading drive shaft 7.

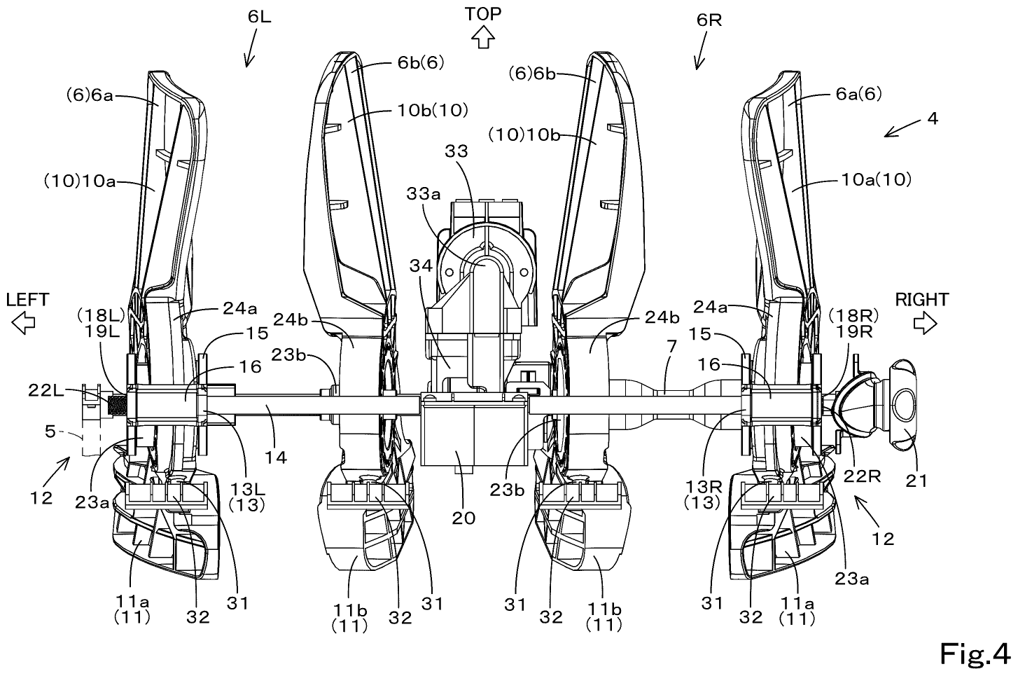

The cam surface 30 of the rotary boss 23 in the outer massage member 6a and the cam surface 30 of the rotary boss 23 in the inner massage member 6b are inclined in opposite directions (refer to FIG. 4 for instance). For example, the two cam surfaces 30 are inclined in a V-like shape when viewed from the front. Thus, the outer rotary boss 23a and the inner rotary boss 23b eccentrically rotate while inclining in opposite directions.

Moreover, in the present example embodiment, the rotary boss 23 is mounted so as to be, with the slide pin 29 and the guide slot 27, slidable in the width direction relative to the kneading drive shaft 7.

The annular fitter 24, which is formed at the base end (bent portion) of the massage member 6, is fitted externally to the rotary boss 23 for free rotation relative to the rotary boss 23. For example, the outer massage member 6a is allowed rocking motion in response to inclined rotation of the rotary boss 23a fitted at the outside with an annular fitter 24a. Moreover, the inner massage member 6b is allowed rocking motion in response to inclined rotation of the rotary boss 23b fitted at the outside with an annular fitter 24b.

The restrainer 25, which is located below the annular fitter 24, restrains the annular fitter 24 from rotating together with the rotary boss 23a (refer to FIGS. 3 and 7, for instance). The restrainer 25 includes a restraint pin 31 located below the annular fitter 24, and a restraint slot 32 in which the restraint pin 31 is slidably fitted. The restraint pin 31 is a member downstanding from the annular fitter 24. The restraint slot 32 is positioned face-to-face with the restraint pin 31. The restraint slot 32, which is located toward the inner bottom of the case body 2, is shaped as a groove elongated in the lateral direction. When slidably received in the restraint slot 32, the restraint pin 31 rocks in the lateral direction within the restraint slot 32.

The above-described converter 9 converts the rotational driving force exerted by the kneading drive shaft 7 into rocking motion, which enables the paired horizontal massagers 11a and 11b, as well as the paired vertical massagers 10a and 10b, to repeat mutual approach-separation movement (kneading massage operation). The operation involves the following successive steps: moving the horizontal massagers 11a, 11b so that they get near each other at their front portions first, and subsequently at their rear portions; moving the vertical massagers 10a, 10b so that they get near each other at their lower portions first, and subsequently at their upper portions; moving the horizontal massagers 11a, 11b so that they get away from each other at their front portions first, and subsequently at their rear portions; and moving the vertical massagers 10a, 10b so that they get away from each other at their lower portions first, and subsequently at their upper portions.

That is, the massage members 6a and 6b apply sandwiching and holding massage, being called squeezing massage, to the calf C with the vertical massagers 10a and 10b falling against each other, and apply squeezing massage to the foot F with the horizontal massagers 11a and 11b in sandwiching movement.

The kneading driver 8 rotatably drives the kneading drive shaft 7, and the converter 9 converts the rotational driving force exerted by the kneading drive shaft 7 into rocking motion, thereby enabling the massage member 6 including the horizontal massager 11 and the vertical massager 10 to perform kneading massage operation. The massage mechanism 4 is operative in this way.

The kneading driver 8 includes a drive motor 33 and a gear case 34. The drive motor 33 produces a rotational driving force. The gear case 34 subjects the rotational driving force to deceleration to a predetermined rate of speed, and transmits the force to the kneading drive shaft 7. The kneading driver 8 is supported by the support 8 located centrally of the interior of the case body 2.

The drive motor 33 is located in an intermediate portion of the interior of the case body 2 in the top-bottom direction, and located between the right inner massage member 6a and the left inner massage member 6a, that is; the drive motor 33 is situated substantially centrally of the interior of the case body 2. The drive motor 33 is mounted with its output shaft. 33a protruding rearward.

The gear case 34 is located below the drive motor 33. A plurality of gears 34a are housed in the gear case 34. The output shaft 33a is inserted in the gear case 34, and the kneading drive shaft 7 is mounted so as to pass through the gear case 34 in the lateral direction. That is, the rotational driving force from the drive motor 33 is outputted through the output shaft 33a, then subjected to deceleration to a predetermined rate of speed in the underlying gear case 34, and transmitted to the kneading drive shaft 7.

The case body 2 is provided at the inner bottom surface with a pressing massage member 35 mounted in a protruding condition. The pressing massage member 35 performs pressing massage on the sole U, including the arch of the foot T, or plantar arch T. During the squeezing massage action of the horizontal massagers 11a and 11b, the pressing massage member 35 applies upward force to the sole U to perform finger-pressure massage-like pressing massage. To apply pressing massage to the soles U of varying size (varying width or length), a plurality of pressing massage members 35 may be provided between the paired horizontal massagers 11a and 11b.

The pressing massage member 35 that massages the sole U may be made to be horizontally movable in response to the horizontal movement of the massage member 6. For example, the pressing massage member 35 may be mounted to the horizontal massager 11 via an arm member. This permits adjustment of the position of the pressing massage member 35 in accordance with the width of the foot. F of the user.

In addition, a rear massage member 36 is located toward the inner rear wall of the case body 2. The rear massage member 36 effects massage action on the rear side of the calf C. The rear massage member 36 that massages the rear side of the calf C may also be made to be horizontally movable in response to the horizontal movement of the massage member 6. This permits adjustment of the position of the rear massage member 36 in accordance with the width of the calf C of the user.

Although not shown in the drawings, the kneading drive shaft 7 may be mounted with a rotating massage member to effect massage action on an area from the rear side of the calf C to the rear side of the ankle K.

### [Operation Modes]

The following describes the modes of operating the lower leg massager 1 according to the embodiment of the present invention.

Firstly, the user adjusts the width between the massage members 6 via the width adjustment mechanism 12 by turning the adjustment grip 21 mounted to the outer side of the lower leg massager 1.

Before inserting the lower leg L into the treatment recess 3, for example, the user increases the width between the massage members 6 by turning the adjustment grip 21 in one direction with the hand. More specifically, a turn of the adjustment grip 21 in one direction causes the guide shaft 14 to rotate in the one direction.

The external thread 22L formed in the left-end side of the guide shaft 14 engages the internal thread 19L formed in the left width adjuster 13L. The engagement enables the width adjuster 13L to move on the guide shaft 14 outward to the left, and the outer massage member 6a of the left-leg massager 6L is guided outward to the left accordingly.

Moreover, the external thread 22R formed in the right-end side of the guide shaft 14 engages the internal thread 19R formed in the right width adjuster 13R, The engagement enables the width adjuster 13R to move on the guide shaft 14 outward to the right, and the outer massage member 6a of the right-leg massager 6R is guided outward to the right accordingly.

That is, with the arrangement using the external threads 22 that are screws whose threading directions are opposite to each other and the internal threads 19 that are screws whose threading directions are opposite to each other, the left width adjuster 13L and the right width adjuster 13R guide the outer massage member 6a of the left-leg massager 6L and the outer massage member 6a of the right-leg massager 6R to horizontally move away from each other (to move outward to the left and to the right, respectively) at the same time. This increases the width between the massage members 6, and thereby allows smooth insertion of the lower leg L into the treatment recess 3.

With the massage members 6 spaced an increased distance away from each other (increased width), the user fits the calf C and the foot F into the upper treatment recess 3a and the lower treatment recess 3b, respectively, at one time. The user then turns the adjustment grip 21 in a reverse direction to rotate the guide shaft 14 in the reverse direction.

The external thread 22L formed in the left-end side of the guide shaft 14 engages the internal thread 19L formed in the left width adjuster 13L. The engagement enables the width adjuster 13L to move inward to the right, and the outer massage member 6a of the left-leg massager 6L is guided inward to the right accordingly.

Moreover, the external thread 22R formed in the right-end side of the guide shaft 14 engages the internal thread 19R formed in the right width adjuster 13R. The engagement enables the width adjuster 13R to move inward to the left, and the outer massage member 6a of the right-leg massager 6R is guided inward to the left accordingly.

That is, with the arrangement using the external threads 22 defining screws whose threading directions are opposite to each other and the internal threads 19 defining screws whose threading directions are opposite to each other, the left width adjuster 13L and the right width adjuster 13R guide the outer massage member 6a of the left-leg massager 6L and the outer massage member 6a of the right-leg massager 6R to horizontally move close to each other (move inward to the right and to the left, respectively) at the same time.

The user continues turning of the adjustment grip 21 until the massage members 6 come into contact with each lower leg L received in the treatment recess 3. Upon a slight contact of the massage members 6 with the lower leg L, the user stops turning of the adjustment grip 21. This process of operation enables the width adjusters 13L and 13R to move in the width direction, and thereby permits stepless widthwise-spacing adjustment for the paired right and left outer massage members 6a. Thus, the width between the massage members 6 (the positions of the massage members 6) can be adjusted in accordance with the width of the lower leg L. Now the lower leg massager 1 is ready for operation.

Instead of the adjustment grip 21, a motor may be used to rotate the guide shaft 14. In this case, the motor is operated not continuously but periodically in a manner such that it stops every rotation of predetermined degrees (e.g., every 90 degrees rotation) or for every rotations of predetermined number of times (e.g., for every five rotations). This enables the width adjusters 13L and 13R to move in the width direction in a step-by-step manner. In another alternative, the adjustment grip 21 may be changed from the grip member configured to turn continuously to a grip member configured to turn stepwise (e.g., on a per-rotation basis). In this case, for example, the guide shaft 14 is not rotated continuously but rotated on a predetermined-degree basis. This enables the width adjusters 13L and 13R to move in the width direction in a step-by-step manner. With the adjustment grip 21 or motor configured for continuous rotation, the width adjusters 13L and 13R are steplessly movable in the width direction.

The user turns the power on by operating a switch of an operating panel mounted to the lower leg massager 1, and actuates the kneading driver 8 to set the massage mechanism 4 in motion. The kneading driver 8 rotatably drives the kneading drive shaft 7.

The converters 9a and 9b convert the rotational driving force exerted by the kneading drive shaft 7 into rocking motion, which enables the paired horizontal massagers 11a and 11b, as well as the paired vertical massagers 10a and 10b, to repeat mutual approach-separation movement (kneading massage operation). The operation involves the following successive steps: moving the horizontal massagers 11a, 11b so that they get near each other at their front portions first, and subsequently at their rear portions; moving the vertical massagers 10a, 10b so that they get near each other at their lower portions first, and subsequently at their upper portions; moving the horizontal massagers 11a, 11b so that they get away from each other at their front portions first, and subsequently at their rear portions; and moving the vertical massagers 10a, 10b so that they get away from each other at their lower portions first, and subsequently at their upper portions.

Thus, the paired massage members 6a and 6b apply squeezing massage to the corresponding one of the left calf C and the right calf C with the vertical massagers 10a and 10b falling against each other, and apply squeezing massage to the corresponding one of the left foot F and the right foot F with the horizontal massagers 11a and 11b in sandwiching movement.

The massage machine 1 according to the embodiment of the present invention is capable of giving comfortable and effective massage to treatment areas of different widths and sizes (e.g., feet F, or lower legs L of different sizes, calves C of different thickness, and arms of different thickness) of users by using the mechanism that adjusts, in accordance with the width or size of a treatment area of a person using the massage machine, the spacing between the massage members that sandwich and hold the treatment area from both sides in the lateral direction.

It should be understood that the embodiment as disclosed herein is considered in all respects as illustrative only and not restrictive.

In particular, for such matters as not explicitly specified in the disclosure of the embodiment, for example, working conditions, operating conditions, and the dimensions, weights, etc. of the constituent components, those that do not depart from the practical range to be normally complied with by persons skilled in the art and that conform to matters of common knowledge among the skilled persons are adopted herein.

For example, the length of the massage member 6 provided in the massage machine 1, the angle of inclination and the degree of eccentricity of the massage member 6 (the cam surface 30 of the rotary boss 23) with respect to the kneading drive shaft 7, and the spaced interval between the paired right and left massage members 6 may be suitably changed in accordance with the range of treatment areas.

Moreover, the width adjustment mechanism 12 provided in the massage machine according to the embodiment of the present invention is applicable to, for example, a massage apparatus configured to massage an arm of a user which is received between massage members provided as a pair in the apparatus. The width adjustment mechanism 12 is also applicable to a device configured to perform kneading massage operation using an eccentrically rotatable shaft. Examples of such a device include a back massage mechanism mounted to a chair-type massager, a massager for neck and shoulders, and a pillow massager.

### REFERENCE SIGNS LIST

1 Massage machine (Lower leg massager)
2 Case body
3 Treatment recess
4 Massage mechanism
5 Support member
6 Massage member
6a Outer massage member
6b Inner massage member
7 Kneading drive shaft
8 Kneading driver
9 Converter
10 Vertical massager
11 Horizontal massager
12 Width adjustment mechanism
13 Width adjuster
14 Guide shaft
15 Plate
16 Coupler
17 Cut-out portion
18 Horizontal hole
19 Internal thread
20 Support member
21 Adjustment grip
22 External thread
23 Rotary boss
24 Annular fitter
25 Restraint part
26 Hole
27 Guide slot
28 Through hole
29 Slide pin
L Lower leg
C Calf
F Foot

1. A massage machine, comprising:
a pair of right and left massage members to hold a treatment area therebetween; and
a width adjustment mechanism to adjust a spacing in a lateral direction between the massage members, wherein
the width adjustment mechanism includes:
a width adjuster mounted to at least one of the massage members to enable the at least one massage member to move in the lateral direction; and
a guide shaft having an axis directed in the lateral direction to guide the at least one massage member in the lateral direction via the width adjuster.

2. The massage machine according to claim 1, wherein
the width adjuster sandwiches the at least one massage member from both sides in the lateral direction,
the guide shaft is passed through the width adjuster in the lateral direction, and
the width adjuster is configured to adjust the spacing in the lateral direction between the massage members by moving on the guide shaft in the lateral direction.

3. The massage machine according to claim 2, wherein
the width adjuster includes:
a pair of plates to sandwich the at least one massage member therebetween on both sides in the lateral direction, the plates each including an opening to keep clear of a kneading drive shaft which is passed through a base end of the at least one massage member; and
a coupler to connect the pair of plates to each other, the coupler including a horizontal hole extending in the lateral direction;
the guide shaft is passed through the horizontal hole; and
the width adjuster is configured to adjust the spacing in the lateral direction between the pair of right and left massage members in such a manner that the width adjuster is guided on the guide shaft to move the at least one massage member fitted with the width adjuster in the lateral direction.

4. The massage machine according to claim 3, wherein
the guide shaft includes an outer periphery formed with an external thread in helical form,
the horizontal hole includes an inner periphery formed with an internal thread with which the external thread of the guide shaft threadedly engages, and
the width adjuster is configured to adjust the spacing in the lateral direction between the pair of right and left massage members in such a manner that, upon a rotation of the guide shaft, the width adjuster is guided with the internal thread engaging the external thread on the guide shaft to move the at least one massage member fitted with the width adjuster in the lateral direction.

5. The massage machine according to claim 4, further comprising:
a left-leg massager and a right-leg massager juxtaposed in the lateral direction, the left-leg massager and the right-leg massager each including the pair of right and left massage members, wherein
the guide shaft is extended in the lateral direction to pass through the horizontal hole of the width adjuster included in the left-leg massager and the horizontal hole of the width adjuster included in the right-leg massager, and
the external threads and the internal threads engaging each other are configured to adjust the spacings in the lateral direction each of which is between the corresponding pair of massage members in such a manner that:
upon a rotation of the guide shaft in one direction, engagement of the external threads and the internal threads causes the at least one massage member of the left-leg massager and the at least one massage member of the right-leg massager to move away from each other; and
upon a rotation of the guide shaft in a reverse direction, engagement of the external threads and the internal threads causes the at least one massage member of the left-leg massager and the at least one massage member of the right-leg massager to move close to each other.

6. The massage machine according to claim 5, wherein
the guide shaft is provided with the external threads, including a right-leg massager-side external thread formed on a portion thereof toward the left-leg massager, and a left-leg massager-side external thread formed on another portion thereof toward the right-leg massager, the right-leg massager-side external thread being a screw whose threading direction is opposite to that of the left-leg massager-side external thread, and
the width adjuster of the left-leg massager and the width adjuster of the right-leg massager are configured to adjust the spacings in the lateral direction each of which is between the corresponding pair of massage members in such a manner that, upon a rotation of the guide shaft, the width adjuster of the left-leg massager and the width adjuster of the right-leg massager move close to and away from each other with the respective internal threads engaging the respective external threads.

7. The massage machine according to claim 3, wherein
the base end of the at least one massage member is provided with a converter to convert a rotational driving force into rocking motion, and
the converter is slidable in the lateral direction relative to the kneading drive shaft that is passed through the converter.

8. The massage machine according to claim 7, wherein
the converter includes:
a rotary boss mounted to the kneading drive shaft to be rotatable together with the kneading drive shaft; and
an annular fitter on the base end of the at least one massage member and fitted externally to the rotary boss, and
the rotary boss is slidable in the lateral direction relative to the kneading drive shaft.

9. The massage machine according to claim 8, wherein
the kneading drive shaft includes a through hole formed therethrough and extending orthogonally to an axis of the kneading drive shaft,
a slide pin is fitted in the through hole, the slide pin being of such a length as to extend radially of the kneading drive shaft and protrude outward from the kneading drive shaft,
the rotary boss includes a hole through which the kneading drive shaft is passed, the hole being formed with a guide slot shaped as a long groove extending axially of the kneading drive shaft, and the guide slot receiving the slide pin slidably fitted thereinto, and
the guide slot and the slide pin that are guidable in the lateral direction are configured to adjust the spacing in the lateral direction between the massage members by guiding the rotary boss in rectilinear sliding movement on the kneading drive shaft in the lateral direction.
